(19) United States
(12) Patent Application Publication
(10) Pub. No.: US 2017/0370768 A1
(43) Pub. Date: Dec. 28, 2017

(54) MICRO-ELECTRO-MECHANICAL-SYSTEMS BASED ACOUSTIC EMISSION SENSORS

(71) Applicant: THE BOARD OF TRUSTEES OF THE UNIVERSITY OF ILLINOIS, Urbana, IL (US)

(72) Inventors: Didem OZEVIN, Chicago, IL (US); Hossain SABOONCHI, Chicago, IL (US)

(21) Appl. No.: 15/542,746

(22) PCT Filed: Jan. 11, 2016
(86) PCT No.: PCT/US2016/012849

§ 371 Date: Jul. 11, 2017

Related U.S. Application Data
(60) Provisional application No. 62/106,500, filed on Jan. 22, 2015.

(51) Int. Cl. G01H 11/06; H04R 7/02; H04R 19/00; H04R 31/00

(52) U.S. Cl. CPC G01H 11/06; H04R 31/00; H04R 7/02; H04R 19/005; H04R 2201/003

(57) ABSTRACT

Acoustic emission (AE) microelectromechanical system (MEMS) transducers of the present disclosure utilize a spring-mass system and a capacitance-change transduction principle. The transducers include a dielectric layer between a fixed electrode and a moveable metal layer to reduce the stiction failure. The moveable metal layer may displace in a particular direction when interacting with elastic waves. Additionally, the moveable metal layer may be formed using an electroplating technique. In some embodiments, multiple spring-mass unit cells may be combined in parallel to increase the sensitivity of the transducer.

### BACKGROUND

Monitoring the integrity and health of structures has become increasingly important in the modern era. When a structure's material undergoes stress that damages or deforms the material, elastic waves are generated and that propagate through the material. This phenomenon is known as “acoustic emission” (AE). Measuring the magnitude and source location of these elastic waves requires instruments called “acoustic emission sensors” or “acoustic emission transducers.” Detecting acoustic emission in real time or near-real time is often desirable for structures whose function may be compromised by a material deformity. For example, a pressurized container, such as a tank or pipeline, might leak out gases or liquids stored therein through cracks or punctures in the structure's material. As another example, a bridge's strength may be reduced by cracks, fiber breakage, or fretting in the bridge's material.

In practice, a number of AE transducers may be placed on the surface of a material. When material stress causes an irreversible deformity, elastic waves emit outwards from the deformity's source location. As the elastic waves propagate through the material, various AE transducers detect the waves at different points in time. Using the time offsets between the detection of the elastic waves at multiple AE transducers, the source location of the elastic waves can be determined.

Conventional AE transducers are based on a transduction principle of piezoelectricity. The typical AE transducer utilizes a piezoelectric ceramic that generates a voltage when strained, compressed, or expanded. However, in order to detect waves having frequencies usually produced by acoustic emission, piezoelectric-based AE transducers must be large in size. Large transducers require a considerable amount of material and thus are expensive.

Some AE transducers have been designed as microelectromechanical systems (MEMS). By utilizing MEMS techniques, the principles of piezoelectric AE transducers have been applied to micro-sized devices. However, piezoelectric-based MEMS AE transducers generally require backing materials and multiple layers of ceramic, adding considerable size to the transducer. Furthermore, miniaturized piezoelectric AE transducers tend to exhibit a low signal-to-noise ratio (SNR), which reduces the sensitivity and accuracy of the transducer's measurements.

Other AE transducers have been designed to utilize a dielectric and MEMS. When an elastic wave interacts with these transducers, a mechanical portion of the transducer moves, causing a change in capacitance (as opposed to a change in voltage in the piezoelectric-based transducers). The capacitance change typically results from a change in the distance between two conductive plates of the transducer or a change in the effective area between the two plates. However, these transducers are typically susceptible to high squeeze film damping—damping caused by the expansion and/or compression of air between the two plates—which reduces the transducer's sensitivity and renders the transducer unable to detect weak elastic waves that are not strong enough to overcome the damping.

### BRIEF DESCRIPTION OF THE DRAWINGS

FIG. 1 illustrates a perspective view of an out-of-plane acoustic emission sensor in accordance with one or more example embodiments.

FIG. 2 illustrates a perspective view of an in-plane acoustic emission sensor in accordance with one or more example embodiments.

FIG. 3 illustrates a perspective view of another in-plane acoustic emission sensor in accordance with one or more example embodiments.

FIG. 4 illustrates a top view of a unit cell in accordance with one or more example embodiments.

FIG. 5 illustrates a top view of an array of unit cells in accordance with one or more example embodiments.

FIGS. 6A-6H illustrate an example manufacturing process in accordance with one or more example embodiments.

### DESCRIPTION

### I. Overview

Acoustic emission transducers—devices that detect and measure the magnitude of elastic waves in a material—may be used to monitor the health and integrity of a variety of structures, such as pressurized tanks, pipelines, and bridges, among others structures. Whatever the application may be, it is desired to have sensors that are reliable, inexpensive, small in size, and highly sensitive. However, acoustic emission transducers typically possess only some of these desired qualities. While piezoelectric transducers—which generate a voltage potential when compressed or expanded—tend to be sensitive to weak elastic waves, they are often large in size and thus require considerable material in each transducer, making such sensors expensive per unit to manufacture. Alternatively, capacitive transducers—which produce changes in the transducer's capacitance from displacement of one or more components of the transducer—are typically susceptible to squeeze film damping, and thus cannot detect elastic waves below a certain magnitude. The damping and low signal to noise ratio phenomenon is particularly prominent when the sensors are small in size (e.g. MEMS transducers).

Generally, capacitive-type AE MEMS transducers have a stationary conductive layer and a moveable conductive layer separated by an air gap. The moveable conductive layer acts as a mass and spring system, and can be described as having spring and damping coefficients. When elastic waves interact with the transducer, the moveable conductive layer vibrates or is otherwise displaced from its rest position, causing a varying separation between the moveable conductive layer and the stationary conductive layer. As a result, the capacitance—which is proportional to the separation between the two conductive layers—varies, indicating the presence of an elastic wave. Certain wave characteristics, such as magnitude and frequency, can be determined from these capacitance fluctuations. However, at micrometer scales, certain forces (e.g. electrostatic, Van der Waals, and hydrogen bonding forces) introduce significant damping between the two conductive layers. This damping prevents the moveable conductive layer from being displaced when subjected to waves having a magnitude below a threshold magnitude.

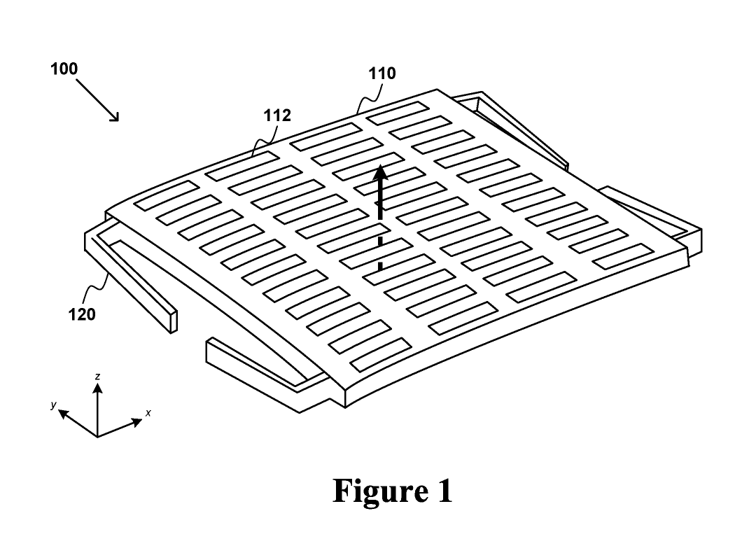

The AE MEMS transducers of the present disclosure significantly reduce the damping problems that typically plague capacitive-type transducers by depositing a dielectric layer between two conductive layers. Additionally, by increasing the thickness of the transducer while maintaining a small planar dimension, a transducer having a high spring coefficient can be produced, thus allowing for a low resonance frequency. Furthermore, the AE transducers of the present disclosure can be designed to displace along a single axis, thus increasing the accuracy of source localization. FIGS. 1, 2, and 3 depict AE sensors that are each designed to displace along a certain axis as indicated by the thick arrows in the figures.

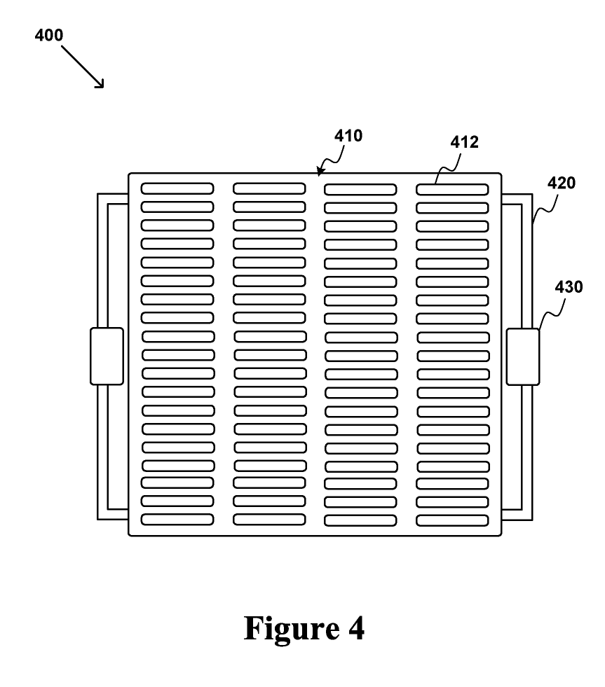

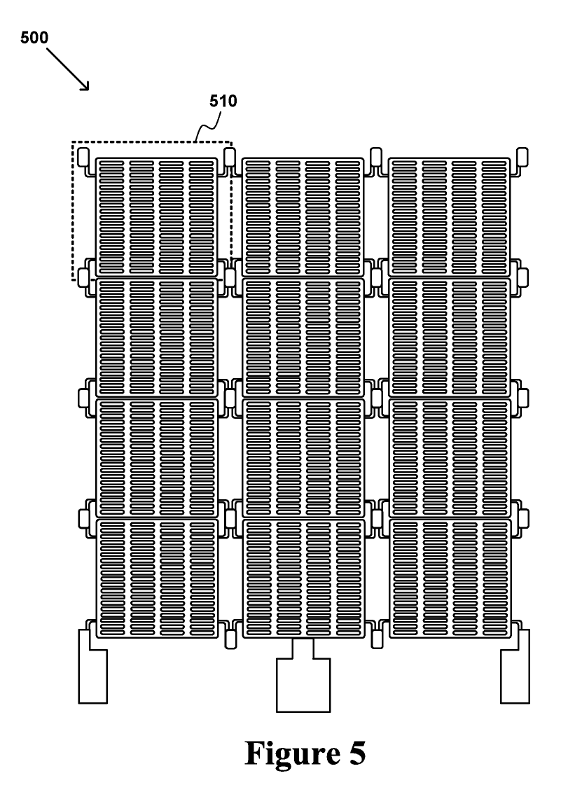

In some implementations, the spring-mass system forms a single “unit cell” of a larger AE transducer. An example unit cell is depicted in FIG. 4. Each unit cell operates independently, and can be connected to other unit cells in parallel to increase the total capacitance of the overall AE transducer. An example array of unit cells is depicted in FIG. 5. The transducer's higher total capacitance correlates to a greater sensitivity.

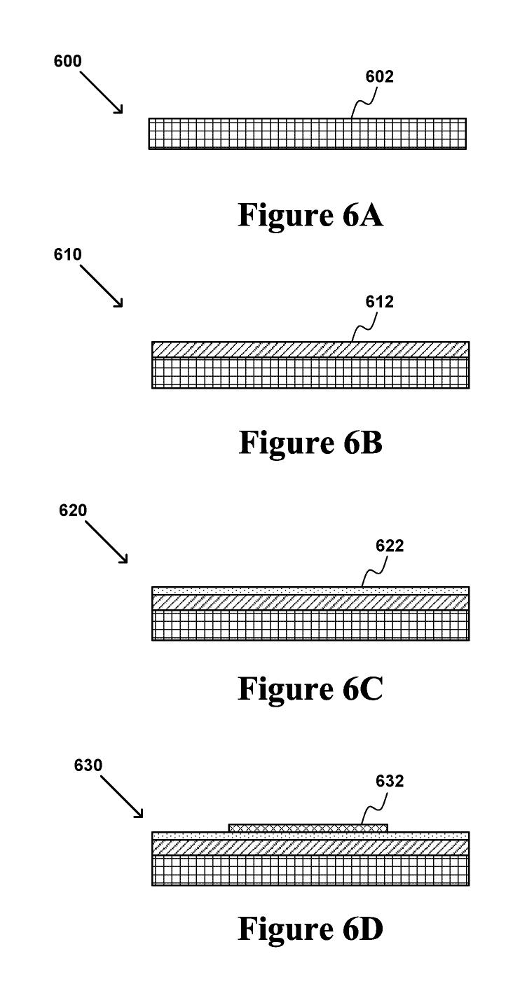

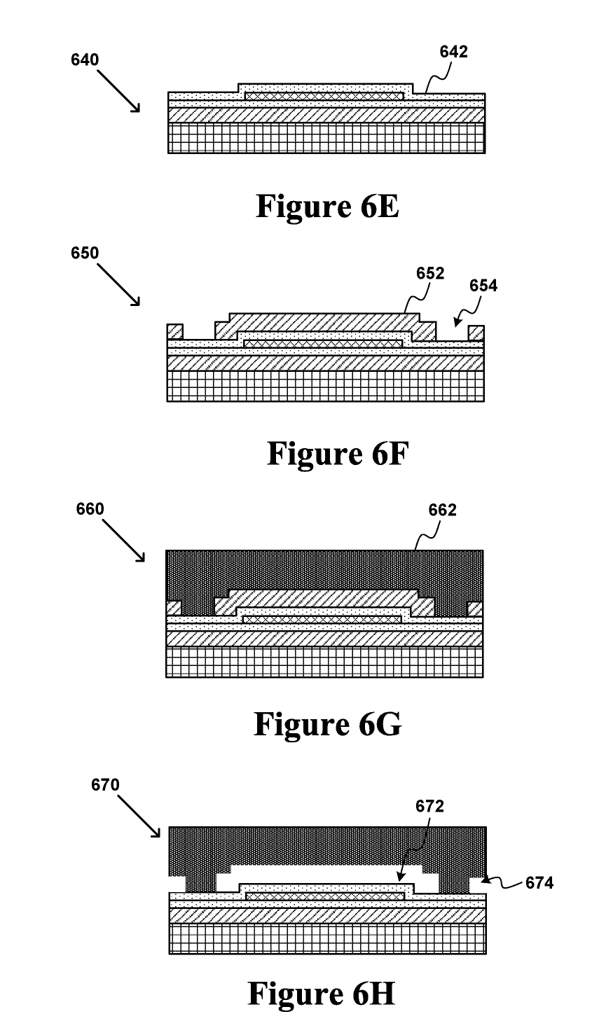

The AE MEMS transducers of the present application may be manufactured using, among other processes, an electroplating technique to produce a thick conductive metal layer. The manufacturing process involves depositing and patterning a stationary conductive layer (which may also be referred to herein as a “fixed electrode”) onto an insulating layer. Then, another insulating layer and a sacrificial layer are overlaid on top of the fixed electrode. Following that, the thick metal layer that forms the spring-mass system is grown onto the sacrificial layer using electrodeposition (i.e. growing the metal onto the sacrificial layer using an electroplating technique). The sacrificial layer is then removed, releasing portions of the metal layer and allowing it to move about. Note that the metal layer is anchored at certain points to the insulating layer on top of the fixed electrode. An example manufacturing process is depicted in FIGS. 6A-6H.

Note that a “sensor” and a “transducer” may be used interchangeably herein, and refer to a device that converts elastic energy having a respective magnitude into a proportionate amount of a different type of energy. The acoustic emission transducers of the present application include components that displace when subjected to elastic waves, which alter the transducer's capacitance.

### II. Example Transducers

An example out-of-plane acoustic emission sensor 100 is depicted in FIG. 1. The metal layer of sensor 100 includes a mass section 110 and four spring sections, including spring section 120. The metal layer of sensor 100 is designed to bow in a direction perpendicular to the plane of the sensor (“out-of-plane”); more precisely, the metal layer is designed to displace in the z-direction, where the x-y plane is the plane of the transducer. The axis of displacement is depicted as a thick black arrow at the center of the transducer in FIG. 1.

The metal layer of sensor 100 may be positioned above another electrode, which may be formed from a conductive material, such as a polycrystalline silicon (“polysilicon”). The metal layer and the electrode may be separated by at least one of a gap of air and/or an insulating layer made of, for example, silicon nitride. As a result, the metal layer and the electrode form a parallel plate capacitor. Thus, as the metal layer displaces in the z-direction, the separation between the metal layer and the electrode causes fluctuations in the sensor's capacitance. Generally, the capacitance of a parallel plate capacitor can be expressed as:

$${C}_{0} = {ɛ}_{0} {ɛ}_{r} \frac{A}{d} \qquad ( 1 )$$

where ε₀ is the vacuum permittivity, εᵣ is the permittivity of the medium between the metal layer and the electrode, A is the area between the electrodes, and d is the distance between the electrodes. For sensor 100, the distance d fluctuates as the mass 110 moves up and down in response to being subjected to an elastic wave. As the distance d increases, the capacitance measured at sensor 100 decreases; conversely, as the distance d decreases, the capacitance measured at sensor 100 increases. By measuring this capacitance change, the magnitude of the elastic wave can be determined.

The magnitude of the elastic wave is proportional to the displacement of the metal layer of sensor 100. The sensor 100 may have a combination of an air gap and an insulating layer between the metal layer and the electrode. The capacitance of such a sensor 100 can be expressed as:

$${C}_{0} = \frac{1}{\frac{1}{{C}_{ins}} + \frac{1}{{C}_{air}}} = {ɛ}_{0} \frac{1}{\frac{{d}_{ins}}{{ɛ}_{ins}} + {d}_{air}} \qquad ( 2 )$$

where Cᵢₙₛ is the capacitance of the insulator, dᵢₙₛ is the thickness of the insulator, εᵢₙₛ is the permittivity of the insulator, Cₐᵢᵣ is the capacitance of air, and dₐᵢᵣ is the distance of the air gap. In some embodiments, the insulator may be Si₃N₄ (having an εᵢₙₛ=7.5) or a different silicon nitride, among other insulators.

During operation, the distance of the air gap fluctuates by a certain amount, represented by z in equation (3):

$${C}_{2} = {ɛ}_{0} \frac{1}{\frac{{d}_{ins}}{{ɛ}_{ins}} + ( {d}_{air} - z )} \qquad ( 3 )$$

Equation (3) can be rearranged to determine the displacement z:

$$z = \frac{{ɛ}_{0} A}{{C}_{2}} - \frac{{d}_{ins}}{{ɛ}_{ins}} - {d}_{air} \qquad ( 4 )$$

Thus, by measuring the capacitance C₂ measured at the sensor 100, the displacement z, which is proportional to the magnitude of the elastic wave, can be determined.

The sensor 100 may be characterized by its capacitance, resonance frequency, and damping. By changing the materials, dimensions, and/or configuration of sensor 100, its characteristics can be modified. For example, a stiff metal layer might increase the damping characteristic of sensor 100. As another example, a larger planar area between the metal layer and the electrode might increase the overall capacitance of sensor 100. Thus, the sensor 100 may be designed to be particularly sensitive to elastic waves having a certain frequency and of a certain magnitude.

In some embodiments, it may be desired to design an AE sensor to have a resonance frequency that is approximately or the same as the expected wave frequencies it is designed to measure. For example, acoustic emission is typically characterized by frequencies that fall within a range of 50 kHz to 200 kHz (although some acoustic emissions are below 50 kHz or above 200 kHz). Accordingly, designing the AE sensor to have a mechanical resonance within that range may greatly increase the sensitivity of the sensor. For instance, when an elastic wave having a certain frequency interacts with the spring-mass system of the sensor with a resonant frequency that is very close to the wave frequency, the oscillations in the spring-mass system produced by the elastic wave may be mechanically amplified.

Generally, the resonance frequency within a single degree of freedom (such as the z-direction for sensor 100) can be represented as:

$$f = \frac{1}{2 π} \sqrt{\frac{k}{m}} \qquad ( 5 )$$

where f is the resonance frequency, k is the spring constant (i.e. the stiffness of the spring), and m is the mass of the system. Thus, to increase the resonance frequency of the sensor, the mass can be decreased and/or the stiffness of the spring can be increased. This may be achieved by using a more lightweight metal, shorter spring legs, a thinner metal layer, or any combination thereof, among others. Conversely, to decrease the resonance frequency of the sensor, the mass can be increased and/or the stiffness of the spring can be decreased. This may be achieved by using a heavier metal, longer spring legs, a thicker metal layer, or any combination thereof, among others.

In some instances, the damping of the spring-mass system of an AE MEMS transducer may be modified by increasing or decreasing the size of the gaps in the mass of the metal layer. By making the gaps smaller in the mass, air that is above or below the mass has smaller holes through which it can be displaced, increasing the sensor's damping. Alternatively, by making the gaps larger in the mass, air that is above or below the mass can move more freely through the holes, decreasing the sensor's damping.

Generally, the damping of the AE MEMS transducers can be represented as follows:

$$\begin{matrix}c = ( \frac{6 {hb}^{2}}{{a}^{3}} + \frac{{b}^{3}}{{g}^{3}} ) η L & ( 6 ) \\ ζ = \frac{c}{2 \sqrt{k m}} & ( 7 ) \\ Q = \frac{1}{2 ξ} & ( 8 )\end{matrix}$$

where c is the damping coefficient, ζ is the damping ratio, and Q is a dimensionless representation of the damping. The damping coefficient c is based on the thickness of the metal layer h, the thickness of the holes a, the thickness of the bar b, the gap between the electrodes g, and the viscosity of air η. Thus, considering the factors that affect the damping of the sensor, desired damping in the sensor may be achieved. While measuring the damping coefficient or the damping ratio may be difficult, the Quality factor Q can be measured from dynamic excitation. Because of the thick mass structure of the metal layer, the design may have a higher Q factor as compared to typical capacitive AE MEMS transducers.

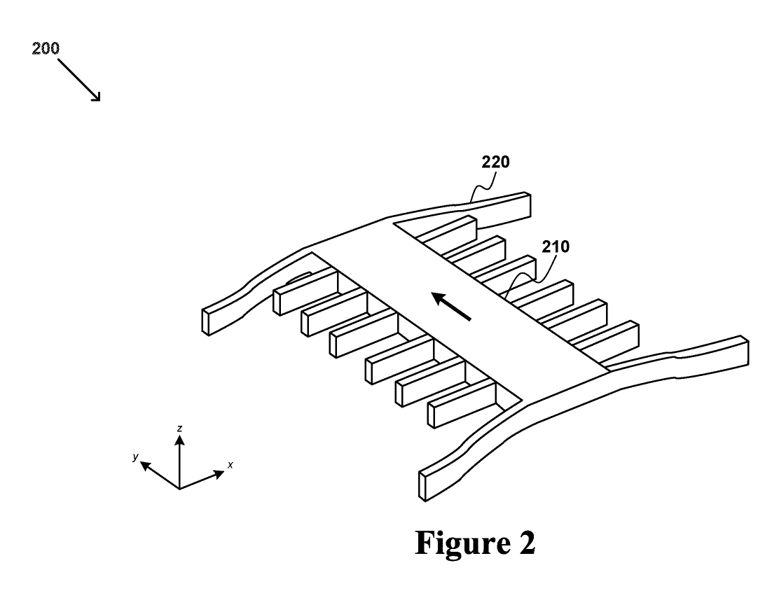

An example in-plane acoustic emission sensor 200 is depicted in FIG. 2. The layer of sensor 200 includes a mass section 210 and four spring sections, including one example spring section 220. The metal layer of sensor 200 is designed to displace in a direction parallel to the springs and fins of the sensor's metal layer (”in-plane“); more precisely, the metal layer is designed to displace in the y-direction, where the x-y plane is in the plane of the transducer. The axis of displacement is depicted as a thick black arrow at the center of the transducer in FIG. 2.

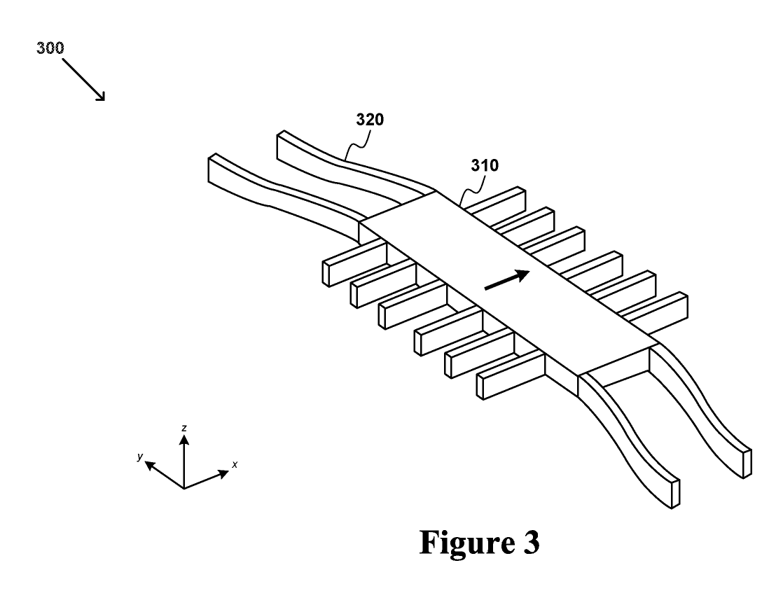

Another example in-plane acoustic emission sensor 300 is depicted in FIG. 3. The layer of sensor 300 includes a mass section 310 and four spring sections, including one example spring section 320. The metal layer of sensor 300 is designed to displace in a direction parallel to the springs and fins of the sensor's metal layer (”in-plane“); more precisely, the metal layer is designed to displace in the x-direction, where the x-y plane is in the plane of the transducer. The axis of displacement is depicted as a thick black arrow at the center of the transducer in FIG. 3.

Note that the mechanical resonance frequency of the “fins” (also referred to as “comb fingers”) of the sensor 200 in FIG. 2 and sensor 300 in FIG. 3 is designed to exceed the frequencies expected from elastic waves to prevent undue interaction or noise produced by vibrations in the fins. In some embodiments, the resonance frequency of the sensor is designed to fall within a range of 50 kHz to 200 kHz, whereas the resonant frequency of the fins is designed to be above 1 MHz. Accordingly, the fins serve to change the capacitance of the sensor when subjected to elastic waves.

### III. Example Configurations

FIG. 4 illustrates a top view of a unit cell 400 in accordance with one or more example embodiments. The unit cell consists of a mass 410, springs, such as representative spring 420, and anchors, such as anchor 430. The unit cell 400 may operate in a similar manner as sensor 100 shown in FIG. 1, and may be manufactured using a process similar the process described in FIGS. 6A-6H. The unit cell 400 may be combined with other similar unit cells, or unit cells of a different configuration, to form a larger transducer.

FIG. 5 illustrates a top view of an array of unit cells 500 in accordance with one or more example embodiments. The array of unit cells contains unit cells, such as unit cell 510 (which may be similar to or the same as unit cell 400) connected in parallel. In some embodiments, the anchors of some unit cells are shared between two or more unit cells of an entire transducer. By constructing the array of unit cells 500 to have the unit cells connected in parallel, a greater capacitance can be achieved compared to the capacitance of a single unit cell. Each unit cell is anchored such that oscillations from a given unit cell may not influence oscillations of other unit cells. As a result, a transducer that includes an array of unit cells may continue to sense acoustic emissions even if one or more of the unit cells are damaged, stuck, or otherwise inoperable, making the transducer more robust. The array of unit cells 500 also include terminals, such as terminal 520, to allow for electrical connections to the transducer for measuring the capacitance changes.

In some embodiments, multiple arrays of unit cells may be included into a single packaged transducer. Each array of unit cells may contain one or more unit cells of the same type. For example, a given transducer may include an array of out-of-plane unit cells and an array of in-plane unit cells combined into a single package. Each array of unit cells may be coupled to one or more terminal pads, such that capacitance changes can be measured for each array of unit cells. A transducer that combines multiple types of arrays of unit cells may be capable of more accurately characterizing elastic waves. Further, certain waves that may be difficult to detect with a certain type of sensor may be more easily detected using a different type of sensor; accordingly, including multiple types of unit cells results in a more robust transducer. Any number of unit cells, each being any type of unit cell, may be combined to form an AE MEMS transducer depending on the particular implementation.

### IV. Example Manufacturing Process

FIGS. 6A-6H depict a cross-sectional side view of an example manufacturing process in accordance with one or more example embodiments. The cross-sectional side views are provided for explanatory purposes, and may not necessarily correspond to an AE MEMS transducer explicitly described in the present application. Note that the dimensions in the figures may not necessarily be drawn to scale. The steps 600-670 are example operations that may be performed in order to manufacture an AE MEMS transducer. Note that other operations, in addition to the ones described in steps 600-670, may be carried out before, during, or after the steps 600-670.

Additionally, the steps 600-670 may be applied to a large substrate that produces many AE MEMS transducers. The jointly-formed transducers may be divided up into individual transducers or separated into smaller arrays of transducers. Further, the separated transducers may be mounted to insulated packaging, such as a ceramic package with epoxy. Other post-processing techniques may also be carried out.

FIG. 6A: Substrate

At step 600, the manufacturing process begins with substrate 602. The substrate 602 may be a silicon wafer. In some implementations, the silicon wafer is an n-type and is highly resistive. The substrate 602 may be rigid, such that most elastic waves do not bend or otherwise affect the substrate's shape. In addition, the substrate 602 may act as an anchor to which additional insulating layers, electrodes, and/or metal components can connect or adhere.

FIG. 6B: Deposit First Insulating Layer

At step 610, the manufacturing process involves depositing a first insulating layer 612 onto substrate 602. This first insulating layer may be formed from one or more sub-layers of silicon oxide, such as SiO or SiO₂. In some implementations, the first insulating layer 612 is grown to have a total thickness of 2.5 μm. This first insulating layer 612 provides insulation between the substrate 602 and the electrode 632 (described below and shown in FIG. 6D).

FIG. 6C: Deposit Second Insulating Layer

At step 620, the manufacturing process involves depositing a second insulating layer 622 onto the first insulating layer 612. The second insulating layer 622 may be relatively thin compared to the first insulating layer 612 (e.g. one-fourth to one-tenth the thickness of the first insulating layer 612). In some implementations, the second insulating layer 622 is grown to have a thickness of 0.35 μm. The second insulating layer 622 may be formed using silicon nitride, such as Si₃N₄. Similarly to the first insulating layer 612, the second insulating layer 622 insulates the electrode 632 from the substrate 602.

FIG. 6D: Form Fixed Electrode

At step 630, the manufacturing process involves forming electrode 632 onto the second insulating layer622. The electrode 632 may be formed using a conductive material, such as a polysilicon. Forming electrode 632 may involve depositing the conductive material onto the second insulating layer 622, and then patterning or etching the deposited conductive material to remove certain sections and/or channels. The pattern of electrode 632 depends on the particular implementation; the pattern of electrode 632 would differ for each of the AE transducers depicted in FIGS. 1, 2, and 3. In some implementations, the electrode 632 has a thickness of 0.7 μm. The electrode 632 may be doped in order to have a desired electrical square resistivity (e.g. 22Ω/sq).

The electrode for the AE sensor 100 depicted in FIG. 1 could take on a variety of patterns. For example, the electrode may be a solid square-shape underneath the mass 110 of the sensor 100. As another example, the electrode may be formed have a similar shape as the mass 110, such that the empty channels of mass 110 do not have an electrode below them, but rather that the electrode is only present underneath the portions of the mass 110 formed from metal. This pattern matching between the electrode and the metal layer of an AE sensor may increase the sensitivity of the AE sensor. The capacitance changes produced for AE sensor 100 results from the displacement of the metal layer away from the electrode.

The electrode for the AE sensor 200 depicted in FIG. 2 could take on a variety of patterns. For example, the electrode may be formed to have a similar shape to the mass 210 of the sensor 200; in other words, the electrode may have a solid center portion, with “wings” or “fins” similar to the mass 210 extending outwards from the solid center portion. At rest, the fins of the mass 210 may be positioned directly above similarly-shaped fins of an electrode. When the mass translates in the direction of the arrow as shown in FIG. 2, the fins of mass 210 may move such that they no longer are above a portion of the electrode. Because the area A as described in equation (1) decreases, so would the capacitance measured at that point in time for sensor 200. Other electrode shapes are possible as well.

The electrode for the AE sensor 300 depicted in FIG. 3 could take on a variety of patterns. For example, the electrode may be formed to have a similar shape to the mass 310 of the sensor 300; in other words, the electrode may have a solid center portion, with “wings” or “fins” similar to the mass 310 extending outwards from the solid center portion. At rest, the fins of the mass 310 may be positioned directly above similarly-shaped fins of an electrode. When the mass translates in the direction of the arrow as shown in FIG. 3, the area A as described in equation (1) changes, resulting in a capacitance change measured at that point in time for sensor 200. Other electrode shapes are possible as well.

FIG. 6E: Deposit Third Insulating Layer

At step 640, the manufacturing process involves depositing a third insulating layer 642 over the patterned electrode 632 and the exposed portions of the second insulating layer 622. Similarly to the second insulating layer 622, the third insulating layer 642 may be made of silicon nitride, such as Si₃N₄. The third insulating layer acts to significantly reduce stiction between the electrode 632 and the spring-mass system formed by metal layer 662. The third insulating layer 642 may also have a similar thickness to the second insulating layer 622 (e.g. 0.2 μm to 1μm).

FIG. 6F: Form Sacrificial Layer

At step 650, the manufacturing process involves forming a sacrificial layer that, when removed at step 670, forms the gaps and channels (which may be referred to herein as “etch windows”) between the metal layer 662 and the third insulating layer 642. Example etch windows are depicted in FIG. 1. The mass 110 of sensor 100 includes a number of etch windows, such as etch window 112. During the manufacturing process, the sacrificial layer is etched or patterned such that the metal layer formed thereafter surrounds the etch windows (and, possibly, on top of the etch windows as well). When the sacrificial layer is removed, the previously-formed etch windows leave gaps in the metal layer. Thus, instead of depositing a metal layer and etching that layer, which may be difficult due to do precisely or safely, the sacrificial layer can be patterned to have the desired shape and then removed after the metal layer is formed. The sacrificial layer may be formed using silicon oxide, such as SiO or SiO₂. In some implementations, the sacrificial layer is 1.1 μm thick.

FIG. 6G: Form Metal Layer

At step 660, the manufacturing process involves forming a metal layer 662 that forms the spring-mass system of the AE MEMS transducer. The metal layer 662 is deposited onto the sacrificial layer 652 and the exposed portions of the third insulating layer 642 through electroplating. This process may be referred to herein as “electrodeposition.” An example electrodeposition technique is described below.

In some implementations, the partially-formed transducer is submerged into an electrolytic solution, which may have dissolved therein metal salts and/or other ions that allow current to flow when subjected to an electric field. One or more pieces of metal may also be present in the electrolytic solution, such as nickel pieces, gold pieces, and silver pieces, among other metals. When a power source generates an electric field in the electrolytic solution, atoms from the one or more pieces of metal may dissolve into the solution and flow in the direction of the electric field onto the partially-formed transducer. The dissolved metal atoms build up onto the surface of the sacrificial layer 652 and the exposed portions of the third insulating layer 642, “plating out” onto those portions of the transducer to create the metal layer 662. This process may be repeated for a number of different metals depending upon the particular implementation.

In some embodiments, a thin layer of anchor metal is deposited onto the surface of the sacrificial layer 652 and the exposed portions of the third insulating layer 642. The anchor metal may provide better adhesion between the subsequent metal layer 662 and the surface of the sacrificial layer 652 and the exposed portions of the third insulating layer 642.

In some embodiments, a thick layer of nickel is electrically deposited. In some implementations, the layer of nickel may be 20 μm thick. The layer of nickel may then be coated with a thin layer of gold also using electrodeposition. In some implementations, the layer of gold may be 0.5 μm thick. The thin layer of gold provides enhanced wire bonding at the points of connection of the metal layer 662 to the third insulating layer 642, and acts to prevent corrosion of the nickel. Collectively the nickel, gold, and any other layers that may have been deposited such as the anchor metal form the metal layer 662.

The sacrificial layer 652 may be formed to create channels in which the spring portions of the metal layer 662 are formed during step 660. A portion of each channel may expose the third insulating layer 642, such that during step 660 the metal layer 662 forms within the channels and adheres to the exposed portions (i.e. anchor windows) of the third insulating layer 642. The length, width, and depth of each channel may correspond to the resulting dimensions of the portions of the metal layer 662 formed therein.

In some embodiments, the metal layer 662 is patterned to form a particular shape, such as the shape of the mass section 110 of sensor 100 in FIG. 1, mass section 210 of sensor 200 in FIG. 2, or mass section 310 of sensor 300 in FIG. 3, among other possible shapes. This may be accomplished using any kind of patterning and/or etching techniques, such as lithography, wet etching, dry etching, or other micromachining techniques.

FIG. 6H: Remove Sacrificial Layer

At step 670, the manufacturing process involves removing the sacrificial layer 652. This step releases the metal layer 662 from the sacrificial layer 652, allowing the metal layer 662 to move while remaining anchored to the third insulating layer 642. In some embodiments, an etchant is applied to the partially-formed transducer, which dissolves and carries away the sacrificial layer 652 from the third insulating layer 642 and the metal layer 662. An etchant may be any chemical that washes away the sacrificial layer 652 while leaving the other layers of the transducer intact. In some implementations, step 670 involves submerging the partially-formed transducer in an etchant to remove the sacrificial layer 652.

Removing the sacrificial layer 652 creates air gaps 672 and 674 between the metal layer 662 and the third insulating layer 642. The air gap 672 acts as a dielectric between the electrode 632 and the metal layer 662. Additionally, the air gaps 672 and 674 provide space for the metal layer 662 to bend and move about in when excited by an elastic wave.

After the sacrificial layer 652 is removed at step 670, additional post-fabrication processes may be performed. For example, if the steps 600-670 produced a large array of unit cells, the large array might be divided into smaller arrays to form a die. In some embodiments, the die may be mounted into a ceramic package with epoxy. The package may provide pins, which are connected to the terminals of the die, through which instruments or other devices may interface with the transducer.

### V. Alternatives

Certain AE MEMS transducers may include a variety of types of unit cells depending upon the particular use of the transducer. A certain structure may be known to produce elastic waves having multiple frequencies that can be measured along multiple axes. To detect these waves, a given AE sensor might include unit cells designed for each expected frequency and each expected axis of measurement. Because of the small size of each unit cell, a transducer having a relatively small package size may include unit cells having a variety of resonant frequencies and designed to measure waves along various axes.

We claim:

1. A method of manufacturing acoustic emission (AE) transducers comprising:
depositing a first insulating layer on a substrate, wherein the substrate comprises an n-type silicon wafer;
depositing a second insulating layer on the first insulating layer;
forming an electrode on the second insulating layer;
depositing a third insulating layer on the electrode;
forming a sacrificial layer on the third insulating layer;
forming a metal component on the sacrificial layer; and
removing the sacrificial layer, wherein the removing provides a separation between the metal component and the third insulating layer.

2. The method of claim 1, wherein the first insulating layer comprises two layers of silicon dioxide.

3. The method of claim 1, wherein the second insulating layer comprises silicon nitride.

4. The method of claim 1, wherein the second insulating layer comprises two layers of silicon oxide.

5. The method of claim 1, wherein forming the electrode comprises:
depositing a conductive layer of polysilicon on the second insulating layer; and
patterning the deposited conductive layer of polysilicon to form the fixed electrode.

6. The method of claim 1, wherein the third insulating layer comprises silicon nitride.

7. The method of claim 1, wherein forming the sacrificial layer comprises:
depositing a layer of silicon oxide on the third insulating layer; and
etching the layer of silicon oxide to form etch windows, wherein the etch windows correspond to a shape of the metal component.

8. The method of claim 1, wherein forming the metal component comprises:
depositing a metal layer on the metal plating base; and
patterning the metal layer to form the metal component.

9. The method of claim 8, wherein depositing the metal layer on the metal plating base comprises:
submerging at least the sacrificial layer in an electrolytic solution, wherein the electrolytic solution comprises dissolved metal salts; and
applying an electromagnetic field between a metallic element and the sacrificial layer, wherein the electromagnetic field causes (i) at least a portion of the metallic element to dissolve in the electrolytic solution and (ii) at least a portion of the dissolved portion of the metallic element to onto transfer the sacrificial layer, wherein the metallic element is at least partially submerged in the electrolytic solution.

10. The method of claim 8, wherein the metal layer comprises nickel and gold.

11. The method of claim 8, wherein forming the metal component further comprises depositing a metal plating base that adheres to the sacrificial layer.

12. An apparatus comprising:
a substrate comprising a wafer;
a first insulating layer having a first side of the first insulating layer coupled to a side of the substrate, wherein the first insulating layer comprises the first side and a second side;
a second insulating layer having a first side of the second insulating layer coupled to the second side of the first insulating layer, wherein the second insulating layer comprises the first side and a second side;
a fixed electrode coupled to the second side of the second insulating layer;
a third insulating layer covering the fixed electrode; and
a metal spring connected to at least a portion of the third insulating layer, wherein the metal spring is configured to displace in at least one degree of freedom in response to an acoustic emission wave interacting with the apparatus.

13. The apparatus of claim 12, wherein the wafer is an n-type silicon wafer.

14. The apparatus of claim 12, wherein the first insulating layer comprises two layers of silicon dioxide.

15. The apparatus of claim 12, wherein the second insulating layer comprises silicon nitride.

16. The apparatus of claim 12, wherein the fixed electrode comprises polysilicon.

17. The apparatus of claim 12, wherein the third insulating layer comprises silicon nitride.

18. The apparatus of claim 12, wherein the metal spring comprises nickel and gold.

19. The apparatus of claim 12, wherein the metal spring is configured to displace along a direction normal to the substrate.

20. The apparatus of claim 12, wherein the metal spring is configured to displace along a direction parallel to the substrate.

21. An acoustic emission (AE) transducer comprising:
a plurality of unit cells, wherein each unit cell comprises:
a substrate comprising a wafer;
a first insulating layer having a first side of the first insulating layer coupled to a side of the substrate, wherein the first insulating layer comprises the first side and a second side;
a second insulating layer having a first side of the second insulating layer coupled to the second side of the first insulating layer, wherein the second insulating layer comprises the first side and a second side;
a fixed electrode coupled to the second side of the second insulating layer;
a third insulating layer covering the fixed electrode; and
a metal spring connected to at least a portion of the third insulating layer, wherein the metal spring is configured to displace in at least one degree of freedom in response to an acoustic emission wave interacting with the AE transducer.

22. The AE transducer of claim 21, wherein the wafer is an n-type silicon wafer.

23. The AE transducer of claim 21, wherein the plurality of unit cells are arranged as a two-dimensional array.

24. The AE transducer of claim 21, wherein the plurality of unit cells are connected in parallel.

25. The AE transducer of claim 21, wherein the plurality of unit cells are arranged as a two-dimensional array.

26. The AE transducer of claim 21, further comprising at least two conductive terminals for connecting an external apparatus to the AE transducer.

27. A method of measuring acoustic emission waves comprising:
measuring a first capacitance value from a transducer, wherein the first capacitance value corresponds to a capacitance between a fixed electrode and a metal spring, wherein the fixed electrode is covered with an insulator, wherein the transducer includes an air gap between the insulator and the metal spring, and wherein the first capacitance value corresponds to the metal spring at a rest position;
receiving, at the transducer, an acoustic emission wave, wherein the acoustic emission wave causes the metal spring to displace in at least one degree of freedom;
measuring a second capacitance value from the transducer, wherein the second capacitance value corresponds to the metal spring at a displaced position;
determining a capacitance change between the second capacitance value and the first capacitance value; and
based on the capacitance change, determining a magnitude of the acoustic emission wave.
